(19) United States
(12) Patent Application Publication
(10) Pub. No.: US 2006/0163857 A1
(43) Pub. Date: Jul. 27, 2006

(54) Gas bag of a restraint device

(75) Inventors: Thomas Britz, Bessenbach (DE); Markus Keutz, Rossdorf (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/338,955

(22) Filed: Jan. 25, 2006

(30) Foreign Application Priority Data
Jan. 25, 2005 (DE) 20 2005 001 182.7

(51) Int. Cl. B60R 21/23

(52) U.S. Cl. 280/743.1

(57) ABSTRACT

A gas bag of a restraint device has a first wall part (14) and a second wall part (16), the first wall part (14) and the second wall part (16) being joined at an attachment section (18) by an adhesive. A bonding agent (20) is added to the attachment section (18) in order to improve the adhesive connection.

### TECHNICAL FIELD

The present invention relates to a gas bag of a restraint device with a first wall part and a second wall part.

### BACKGROUND OF THE INVENTION

Known gas bags of occupant restraint devices are made up of two fabric sections, the sections being joined to each other at a circumferential edge. In this context, the joining of the two sections can be accomplished either by a circumferential stitched seam or an adhesive.

In gluing gas bags, preprocessing methods such as fluorination or flame-treatment of the surface are known to improve the-adhesion of the glue to the gas bag.

The present invention proposes a gas bag that can be manufactured in a cost-effective manner using an adhesive connection.

### BRIEF SUMMARY OF THE INVENTION

According to the invention, a gas bag of a restraint device comprises a first wall part and a second wall part, the first wall part and the second wall part being joined at an attachment section by an adhesive. A bonding agent is added to the attachment section in-order to improve the adhesive-connection. Because the gas bag is made up of a first and a second wall part, the two wall parts must be joined to each other.. In this context, the two wall parts are joined at the attachment section. To enable the glue to achieve the necessary adhesion to the fabric of the gas bag, a bonding agent is used, i.e., a material that improves the adhesive strength of materials being combined with each other, so that an adhesive connection between the two wall parts is made possible and improved. The bond of the two wall parts of the gas bag must stand up to significant mechanical stresses when the gas bag is inflated. This is achieved by the adhesive connection because it can withstand high shearing stresses.

The bonding agent is preferably provided in point-wise fashion. The bonding agent can be applied at the locations where it is necessary. Thus, the joining of the two wall parts is cost-effective. Point-wise should define that the bonding agent covers or has a small surface area which is distanced from an adjacent point-like bonding agent area.

The attachment section is preferably provided over its entire surface with a layer of the bonding agent.

The gas bag is made of fibers, the bonding agent preferably being integrated in the fibers of the gas bag. The bonding agent is integrated in the fibers before the fabric is woven by the bonding agent being directly compounded with the fiber material. For this purpose, the average diameter of the bonding agent particles lies in a range of some lm or fewer. By integrating the bonding agent particles in the fibers, the bonding agent can be added already in the factory where the fabric is manufactured.

The bonding agent can also be applied as a coating. In this context, the fabric of the gas bag is woven from a fiber material and is provided with a thin layer of the bonding agent.

The bonding agent is made of, e.g., metal oxide. As bonding agents, it is also possible to use ethylene/acrylamide-comonomers, polymer isocyanates or reactive organic silicon compounds, which harden through drying or polymerization.

According to one specific embodiment, the wall parts are joined in the attachment section exclusively using the adhesive connection. As a result, it is possible to completely do without sewing the wall parts together, so that the two wall parts can be glued to each other in one step, and a cost-effective bond is produced.

The first wall part is preferably a front wall, and the second wall part is preferably a rear wall of the gas bag.

The attachment section can run around the circumference of the gas bag uninterruptedly. Thus a circumferential stitched seam can be omitted, and the wall parts of the gas bag can be glued to each other all around in one single step.

### BRIEF DESCRIPTION OF THE DRAWINGS

FIG. 1 depicts a view of a gas bag according to the present invention of a restraint device in the uninflated, spread-out state,

FIG. depicts a perspective view of the gas bag from FIG. 1 in the inflated state,

FIG. 3 depicts a sectional view of the gas bag according to the present invention in accordance with a first embodiment, and

FIG. 4 depicts an enlarged section of the area designated as X in FIG. 2 of the gas bag according to the present invention in accordance with a second embodiment.

### BRIEF DESCRIPTION OF THE PREFERRED EMBODIMENTS

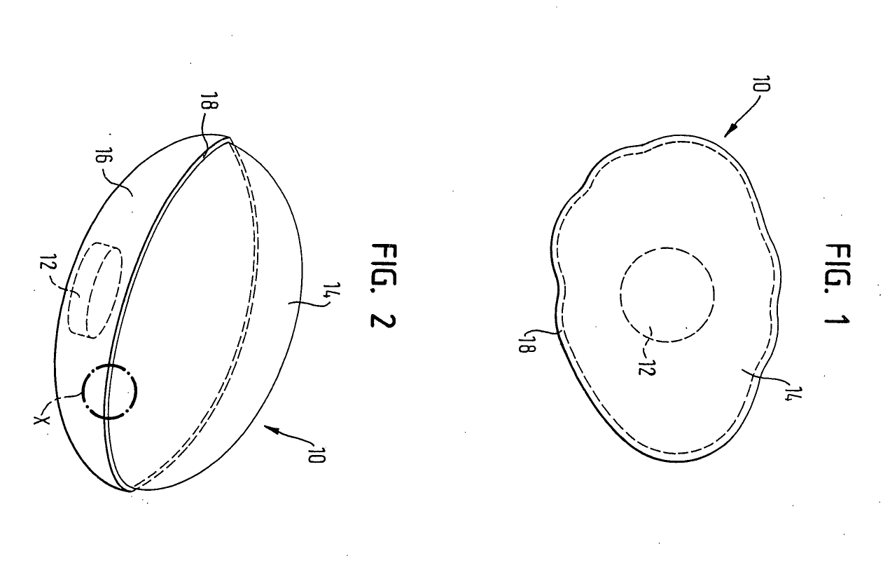

In FIG. 1, a gas bag 10 is depicted as a part of a restraint device. Gas bag 10 can be a part of a driver, side, or passenger airbag module, or the like. Gas bag 10 is made up of a first wall part 14 and a second wall part 16 (see especially FIG. 2). First wall part 14 is here a front wall of gas bag 10, whereas second wall part 16 is a rear wall of gas bag 10. In this context, a schematically depicted gas generator 12, which is part of the restraint device, is connected to second wall part 16. In the uninflated state of gas bag 10, both wall parts 14, 16 lie flat and even one on top of the other (see FIG. 1).

Both wall parts 14, 16 are joined to each other at an attachment section 18. Attachment section 18 runs along the edge of wall parts 14, 16 and therefore runs uninterruptedly around the circumference of gas bag 10. Wall parts 14, 16 are joined to each other in attachment section 18 using an adhesive connection, i.e., wall parts 14, 16 are glued at the edge around the circumference. However, it could also happen that partial areas of attachment section 18 are joined by a stitched seam (not depicted).

A bonding agent 20 is provided to improve the adhesion of a glue 26 (see FIG. 4) to attachment section 18 of first and second wall parts 14, 16 of gas bag 10. Bonding agent 20 is understood to indicate a material that improves the adhesive strength of materials being combined with each other. As bonding agents 20, for example, it is possible to use metal oxides, ethylene/acrylamide-comonomers, polymer isocyanates, or reactive organic silicon compounds, that harden through drying or polymerization.

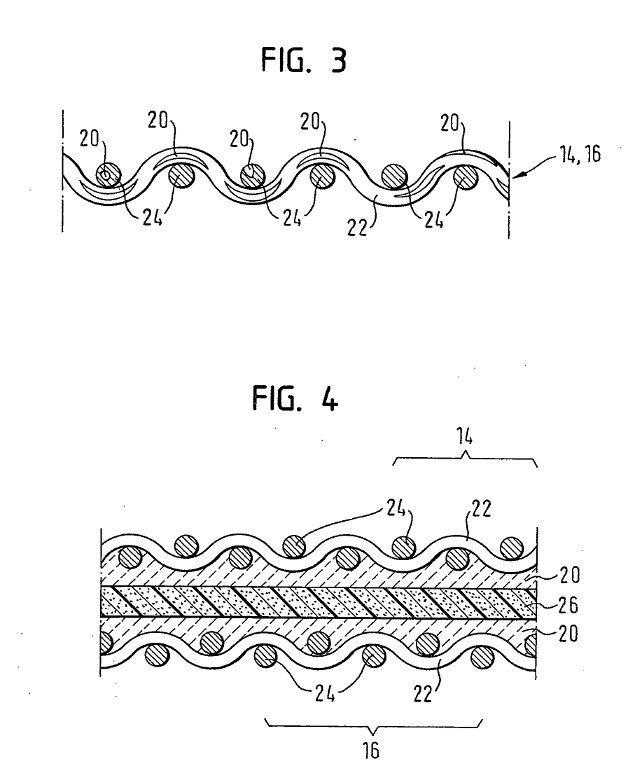

In a first embodiment, bonding agent 20 is applied in point-wise fashion and is integrated in the fibers of gas bag 10. FIG. 3 shows bonding agent 20 in enlarged proportions. Gas bags 10 are generally made of plastic fibers, in particular warp threads 22, which are longitudinal threads, and woof threads 24. To integrate bonding agent 20 into the fibers of gas bag 10, bonding agent 20 is compounded with the fiber material before the gas bag is woven. The particles of bonding agent 20 have a diameter of only some gm or fewer. On attachment section 18, it is then possible to apply the glue (not shown in FIG. 3), which because of bonding agent 20 now adheres better to the fabric of gas bag 10.

In FIG. 4, a second embodiment of gas bag 10 is depicted. The fabric of gas bag 10 is woven from a fiber material and is made up of warp and woof threads 22, 24. Attachment section 18 of both wall parts 14, 16 is provided with a layer of bonding agent 20 over its entire surface or in point-wise fashion, i.e., a thin coating is applied. In this context, the coating of the fabric of gas bag 10 makes it possible to improve the adhesive connection of both wall parts 14, 16, and glue 26 bonds better to the fabric of gas bag 10. Alternatively, a bonding agent 20 of course can be both integrated in threads 22, 24 and also be provided as a layer.

By adding bonding agent 20, the adhesive connection between first and second wall parts 14, 16 is improved. In this context, the adhesive connection can withstand the existing mechanical stresses during the inflation of gas bag 10, and it is possible to dispense with the sewing of wall parts 14, 16.

To produce the inflated state in accordance with FIG. 2, gas generator 12 (depicted schematically) is activated by an impact sensor (not shown), and gas bag 10 is inflated.

1. A gas bag of a restraint device, having
a first wall part (14) and
a second wall part (16),
said first wall part (14) and said second wall part (16) being joined at an attachment section (18) by an adhesive,
wherein a bonding agent (20) is added to said attachment section (18) in order to improve said adhesive connection.

2. The gas bag as recited in claim 1, wherein said bonding agent (20) is provided in point-wise fashion.

3. The gas bag as recited in claim 1, wherein said attachment section (18) over its entire surface is provided with a layer of said bonding agent (20).

4. The gas bag as recited in claim 1, wherein said gas bag (10) is made of fibers, said bonding agent (20) being integrated in said fibers of said gas bag (10).

5. The gas bag as recited in claim 1, wherein said bonding agent (20) is applied as a coating.

6. The gas bag as recited in claim 1, wherein said bonding agent (20) is made of metal oxide.

7. The gas bag as recited in claim 1, wherein said wall parts (14, 16) are joined in said attachment section (18) at least along a predetermined distance exclusively using said adhesive connection.

8. The gas bag as recited in claim 1, wherein said gas bag (10) has a front wall and a rear wall, said first wall part (14) being said front wall, and said second wall part (16) being said rear wall of said gas bag (100).

9. The gas bag as recited in claim 1, wherein said gas bag (10) has a circumference, said attachment section (18) running around said circumference of said gas bag (10) uninterruptedly.
